(19) United States
(12) Patent Application Publication
(10) Pub. No.: US 2025/0112287 A1
(43) Pub. Date: Apr. 3, 2025

(54) METHOD FOR PREPARING BATTERIES TO BE RECYCLED AND PROCESSING PLANT

(71) Applicants: SCHOLZ RECYCLING GMBH, Essingen (DE); ANDRITZ AG, Graz (AT)

(72) Inventors: Uwe HERMSDORF, Lichtenau (DE); Philipp GIEßNER, Leipzig (DE); Kay WEIßFLOG, Rötha (DE); Lutz WUSCHKE, Westewitz (DE)

(21) Appl. No.: 18/727,924

(22) PCT Filed: Dec. 19, 2022
(86) PCT No.: PCT/DE2022/100968

§ 371 Date: Jul. 10, 2024

(30) Foreign Application Priority Data
Jan. 11, 2022 (DE) 10 2022 100 468.6

(51) Int. Cl. H01M 10/54; C22B 1/02; C22B 1/24

(52) U.S. Cl. CPC H01M 10/54; C22B 1/02; C22B 1/24

(57) ABSTRACT

The invention relates to a method for preparing batteries (100) to be recycled, having at least the following steps:
comminuting a provided battery (100) to be recycled in order to obtain comminuted material (101), the provided battery (100) to be recycled and/or the comminuted material (101) obtained therefrom being thermally pre-treated in a comminuting chamber (3a) by being heated up to a comminuting temperature (TZ), which is lower than 100° C.;
transferring the comminuted material (101) into a drying container (4a) and thermally treating the comminuted material (101) by raising an actual ambient temperature (Tlst) and lowering an actual ambient pressure (plst) in the drying container (4a), in order to heat the comminuted material (101) in the drying container (4a), wherein the actual ambient temperature (Tlst) in the drying container (4a) is set such that the comminuted material (101) is heated to no higher than 200° C., and the actual ambient pressure (plst) in the drying container (4a) is set such that both the low-boiling solvent (LL) as well as the high-boiling solvent (LH) are separated by being evaporated out of the comminuted material (101) at the set actual ambient temperature (Tlst), where the low-boiling solvents (LL) and the high-boiling solvents (LH) are discharged out of the same drying container (4a) during the thermal treatment of the comminuted material (101); and
mechanically processing the des thermally treated comminuted material (101).

The invention relates to a method for preparing batteries to be recycled, for example, Li-ion batteries, as well as a processing plant for carrying out the method.

Due to increasing demand for rechargeable batteries (accumulators), in particular, containing Li-ion battery cells, both for off-line, small electronic devices (headphones, mobile phones, etc.) as well as for electric vehicles (traction batteries) or conventional vehicles (starter batteries) respectively or as energy storage banks e.g., for photovoltaic systems or as buffers for energy peaks, in the future there will be increased amounts of Li-batteries to be recycled, when they have reached the end of their life cycles. This is usually the case after 8-10 years, when the capacity of the batteries has been degraded to 80% or less.

For processing old batteries mechanical recycling routes have been designed and realised. Usually, as part of such processing scenarios, a number of mechanical, electric and chemical or, respectively, thermal processes are provided serving to dismantle the batteries or battery cells respectively into their fragments while minimising the electric hazard potential emanating, in particular, from fires, explosions and harmful emissions resulting there from. The electric processes include, in particular, a preparatory discharging of the batteries, and the mechanical processes include, in particular, a preparatory disassembling, mechanical comminution as well as a subsequent sorting/classification with corresponding removal of the respectively contained components.

In addition, in particular, thermal processes ensure that the chemical substances continued in the battery to be recycled, in particular, solvents of an electrolyte of the individual battery cells or other electrochemically active substances, are evaporated or deactivated respectively, for example, using a preparatory drying step at an appropriate drying temperature. Following such thermal pre-treatment these electrochemically active substances no longer present an increased hazard potential when subsequently processed. In addition, a pyrolysis at very high decomposition temperatures of up to 900° C. may be provided as a thermal process, in particular, to decompose a binder holding the active material (Lithium) of the battery cell thereby allowing the active material to be reclaimed. An example of this has been described in the document DE 10 2011 110 083 B4. However, this pyrolysis process also decomposes further electrochemically active solvents thereby making it impossible to utilise these solvents for later recycling.

Hereby, thermal pre-treatment of used batteries or, respectively, of the individual battery cells contained therein for evaporating the solvents of the electrolyte is also known, for example, from the company ACCUREC/Mühlheim, according to which thermal pre-treatment at drying temperatures of about 200° C. is combined with a pyrolysis process in a vacuum oven. Hereby, in the pyrolysis process at decomposition temperatures of between 400° C. and 500° C. the entire organic components of the batteries or battery cells respectively (shell and separator plastics, electrolytes and further organic components) are converted to in pyrolysis gas and pyrolysis coke. The components contaminated by the pyrolysis coke can subsequently be cleansed and separated in a conventional mechanical processing procedure using mechanical comminution and sorting or classification respectively.

A disadvantage of this is that the pyrolysis in a rotary kiln or shaft furnace requires very high decomposition temperatures so that the pyrolysis process is relatively demanding and expensive and also creates disadvantageous odours. Moreover, the recycling of high-quality film components from the pyrolysis coke is difficult and the pyrolysis coke remaining after sorting/classification must be expensively disposed of as hazardous waste rendering the entire processing procedure less economical.

In order to overcome this, the citation DE 10 2015 207 843 B4 provides, for example, in a processing arrangement (battery processing plant), after electrically discharging the batteries or battery cells respectively, in a continuous process to firstly mechanically comminute them and then to deactivate them via a conveyor in a thermal process by drying, where low drying temperatures or about 80° C. or less are set. Subsequently. the deactivated batteries are transported to further mechanical processing in the continuous process via a further conveyor.

A disadvantage of this is that this allows for separation of merely the low-evaporating or, respectively, low-boiling solvents of the electrolyte in the battery cell. In order to be able allow of the removal also of further components of the electrolyte from the comminuted batteries, the document WO 2021/018372 A1 provides that after deactivation of the batteries at 80° C. or less in a further step the already deactivated comminuted material is transferred to an additional container in which the already deactivated comminuted material is then heated up to a electrolyte separating temperature of more than 100° C., in particular, more than 150° C. Hereby, additionally, a vacuum may be generated which, however, is not a prerequisite. This additional heating up to more than 100° C. is intended to remove even high-boiling solvents of the electrolyte. Subsequently the comminuted material is solubilised using concentrated sulphuric acid to remove fluorine from the comminuted material and to obtain solubilised material from which at least one metal component can subsequently be wet-chemically extracted.

A disadvantage of this is that with the electrolyte removal temperatures, specified in the document WO 2021/018372 A1, which are set after deactivation in the additional container, it cannot be ascertained that all high-boiling solvents can also be removed from electrolyte. Very high evaporation temperatures would be required for separating all high-boiling solvents. Moreover, substances in the comminuted material containing plastics would begin to melt at such high temperatures thereby altering the comminuted material in an undesired manner.

Furthermore, the method of WO 2021/018372 A1 is complex because the comminuted material must be transferred into multiple containers suitable for the respective process step for the prior deactivation and the subsequent removal of the high-boiling solvents, thereby requiring temperature adjustments multiple times accordingly, rendering the process complex and also slow. Accordingly, the respectively evaporating solvents components are then also transported away from different containers via different flow connectors, requiring a more complex plant installation.

The citation EP 3 312 922 A1 provides to transport away merely the low-boiling solvents, where in the case of the specified ambient temperatures of less than 80° C. and in the case of the specified ambient pressures of no more than 300 hPa evaporation of only the low-boiling solvents can be ascertained. On the other hand, evaporating and transporting away of high-boiling solvents from the dryer for subsequent exhaust processing is not being described explicitly.

The document EP 3 836 290 A1 further provides for the batteries to be thermally treated prior to comminution and hereby setting, in a first process step, in the drying container an actual ambient temperature of between 160° C. and 200° C. and an actual ambient pressure of less than 10 mbar, to be able to transport away high-evaporating and low-boiling solvents from the battery and feed them to a condenser. Subsequently, in a second process step, the temperature is then further increased to up to 600° C., to allow separation of further decomposition products such as hydrocarbons.

A disadvantage of this is that, for one thing, very high temperatures are required, and, for another, the solvents are extracted from the not yet comminuted batteries making the process less effective and uneconomic overall. Thus, for example, it cannot be ascertained that, in a drying step prior to comminution, the solvents can be discharged completely from the still partly closed battery and that the entire battery can be heated evenly sufficiently in the first process step to securely achieve the appropriate boiling temperatures for evaporating the respective solvents within the entire battery.

It is therefore the object of the present invention to specify a method or a processing plant by means of which the batteries to be recycled can be processed simply or, respectively, with less effort in terms of time and design and with little hazard potential.

This task is solved according to the invention by a method and a processing plant according to the independent claims. Preferred further developments are described in the sub-claims.

Thus, according to the invention, in a method for preparing batteries to be recycled, in particular, Li-ion-batteries, at least the following steps are provided:
providing at least one battery to be recycled, the same, preferably, having been suitably prepared, in particular, disassembled (e.g., to a module level or a cell level) and/or discharged;
comminuting the provided battery to be recycled, in order to obtain comminuted material, preferably being carried out in a comminuting chamber under inert gas and slightly negative pressure, where the provided batteries and/or the comminuted material resulting from these already being heated, as part of a thermal pre-treatment, in the comminuting chamber up to a comminution temperature of, for example, <100° C., in particular, between 50° C. and 70° C., which can contribute to an increased effectivity of the subsequent drying step;
transferring the comminuted material into a drying container and thermally treating or, respectively, drying the comminuted material by raising an actual ambient temperature and lowering an actual ambient pressure in the drying container, preferably under an inert gas atmosphere, in order to heat the comminuted material in the drying container and evaporate solvents contained in the comminuted material, wherein, according to the invention, the actual ambient temperature in the drying container is set such that the comminuted material is heated to no higher than 200° C., and the actual ambient pressure in the drying container is set in such a manner adapted hereto that both low-boiling solvents as well as high-boiling solvents are separated by being evaporated out of the comminuted material at the set actual ambient temperature, where the low-boiling solvents and the high-boiling solvents are discharged out of the drying container during the thermal treatment of the comminuted material, together, at least temporarily, and/or fractionally or separately respectively from one another, at least temporarily, from the same drying container; and subsequently
mechanical processing of the thermally treated or, respectively, dried comminuted material.

Thus, advantageously, a purposeful adjustment of the actual ambient pressure and the actual ambient temperature in the drying container happens during the thermal (main) treatment in such a way that the actual ambient temperatures in the drying container can be maintained so low that a melting of plastic containing substances in the comminuted material can be avoided while at the same time allowing for a separation of the high-boiling solvents so as to minimise the hazard potential for subsequent processing. Thus, the purposeful adjustment of the actual ambient pressure allows working in temperature ranges that do not have a negative effect on the processing procedure in this state of the thermal treatment as well as later on.

In contrast to the procedure according to WO 2021/018372 A1, the invention provides for a purposeful and co-ordinated setting and adjustment of a negative pressure in the drying container during the thermal treatment for the specific purpose of securing a separation of all solvent components in the electrolyte, in particular, including the high-boiling solvents, in the specified temperature range of less than 200° C. This is based on the idea that the evaporation temperatures of the high-boiling solvents in the comminuted material also become lower when the actual ambient pressure drops. Thus, when a lower actual ambient pressure in the drying container is purposefully set, these high-boiling solvents are able to evaporate already at actual ambient temperatures of less than 200° C. Preferably, hereby, it is assumed that it is sufficient to bring the actual ambient temperature up to pre-determined final ambient temperature of between 150° C. and 200° C., preferably 150° C., during the thermal treatment in the drying container.

Because at such actual ambient temperatures it is then possible also for the low-boiling solvents to evaporate, all separated or, respectively evaporated solvent components can be discharged in only one thermal (main) processing procedure from the same drying container, at least temporarily together and/or at least temporarily fractionally (depending on the ambient conditions), and subsequently transferred to a separate exhaust. Hereby, a high-boiling solvent shall be understood as a solvent evaporating under atmospheric pressure at a boiling temperature of higher than 150° C., in particular, higher than 240° C., while a low-boiling solvent evaporates under atmospheric pressure at a boiling temperature of less than 150° C., in particular, less than 130° C.

Preferably, it is hereby also provided that the comminuted material is not discharged from the drying container during the thermal treatment between separating the low-boiling solvents and separating the high-boiling solvents, each by evaporation, so as to allow discharging of the low-boiling solvents and the high-boiling solvents from the same drying container.

Thus, overall, the plant or, respectively design complexity for a processing plant is reduced because the main part of the thermal treatment is carried out merely in one drying container which is adapted to such thermal treatment for discharging all still present low-boiling and high-boiling solvent components and from which all these evaporating solvent components can be discharged temporarily together and/or temporarily separate from one another. Thus, no separate design of plant components is necessary and, likewise, no technically separated discharging of the individual solvent components or even other substances created.

Hereby, the at least partial separation of the low-boiling solvents in the thermal pre-treatment already during the comminution can be carried out with little effort and without an additional container, where this does not even compromise the comminution process in in this area of the plant but, rather, more likely minimises the hazard potential. Furthermore, this thermal pre-treatment can increase the effectiveness of the subsequent separation process or, respectively, the subsequent thermal (main) treatment in the drying container, in which then still both low-boiling (remaining) and high-boiling solvent components evaporate. In particular, the thermal pre-treatment during the comminution process allows for water present in the comminuted material to be evaporated early already thereby, in particular, impairing the subsequent thermal treatment process in the drying container to a lesser extent. Also, the low-boiling solvents separated in the thermal pre-treatment can also be discharged and, for example, transferred to exhaust treatment, for example, the same exhaust treatment procedure to which also the solvents discharged from the drying container are subjected.

Moreover, the procedural complexity is also minimised because for the main part of the thermal treatment in only one separate drying container no multiple temperature adjustments to temperatures between 150° C. and 200° C. (complete heating-up and cooling-down of the drying container or, respectively, of the comminuted material) and no multiple pressure treatments (complete evacuation and aeration of the drying container) with in-between transfers of the comminuted material. Since the comminuting chamber operates under negative pressure and under inert gas anyway, the time and expenditure beyond that in terms of process and design technology for heating the comminuted material as part of the thermal pre-treatment is comparatively small. In this case, for example, the heating of the comminuted material is attained in that a suitably temperature-controlled gas flow is introduced into the comminuting chamber and/or that the environment is heated in some other way. Moreover, the subsequent transfer of the comminuted material from the comminuting chamber into the drying container has to be carried out anyway.

Consequently, the invention reduced the complexity in term of both the design as well as the process or time respectively. Hereby, in particular, it is also provided that the comminuted material prior to being transferred to the drying container is additionally thermally pre-treated merely, if at all, in the comminuting chamber, and/or the comminuted material, prior to being mechanically processed, is thermal treated in the drying container and thermally pre-treated in the comminuting chamber.

Preferably, it is further provided that during the thermal treatment of the comminuted material the actual ambient pressure in the drying container is reduced to a final ambient pressure of between 0.01 mbar and 100 mbar, in particular, between 30 mbar and 100 mbar, preferably 30 mbar. In the case of such low actual ambient pressures in the drying container the boiling temperatures or evaporation temperatures respectively of the solvents still present in the comminuted material can be lowered to such a low value that an actual ambient temperature of a maximum of 200° C., preferably about 150° C., is sufficient to separate or, respectively, evaporate these from the comminuted material.

Preferably, it may further be provided that during the thermal treatment of the comminuted material the actual ambient pressure in the drying container is temporarily raised to a pre-determined intermediate ambient pressure, lying, for example, between 500 mbar and 1000 mbar, preferably at 1000 mbar, preferably starting from the previously set final ambient pressure of between 0.01 mbar and 100 mbar, in particular, between 30 mbar and 100 mbar, and after a holding time the actual ambient pressure is again reduced starting tom the intermediate ambient pressure, preferably to the final ambient pressure. Meanwhile the actual ambient temperature in the drying container preferably remains unchanged, i.e., maintained accordingly high.

Advantageously, the increase of pressure temporarily “fills” gas or air molecules into the drying container again, so that the comminuted material in the drying container, which may have slightly cooled off due to the reduced number of gas or air molecules at lower actual ambient pressures, can heat up again during the holding time. Hereby, the pressure increase is caused by introducing, for example, nitrogen or another inert gas, so as not to compromise the drying process. When the actual ambient pressure is again reduced later, the solvent components can be separated or evaporated respectively due to the lowering of the boiling temperatures. Thus, this way it can be ascertained that the respective solvents will evaporate during the entire thermal treatment in the drying container.

To further optimise this, it may preferably be provided that this temporary raising of the actual ambient pressure in the drying container up to the intermediate ambient pressure, for example, by introducing nitrogen or another inert gas, and the subsequent reducing of the actual ambient pressure after the holding time is carried out multiple times during the thermal treatment of the comminuted material in the drying container. Thus, the evaporation process, in a quasi-pulsed manner, “triggered” again and again or, respectively, it is prevented that the comminuted material cools down to such an extent that the boiling temperatures or evaporation temperatures respectively of the high-boiling solvents are no longer reached. This way a consistent separation or evaporation respectively of the solvents can be almost completely assured so that it can be assumed with high probability that upon conclusion of the thermal treatment process in the drying container only very little chemical hazard potential is posed by the comminuted material because ideally the solvents have fully evaporated.

Preferably, it is further provided that the actual ambient pressure in the drying container during the increasing of the actual ambient temperature in the drying container is not reduced until the actual ambient temperature has reached the pre-determined final ambient temperature, for example, between 150° C. and 200° C., where up until then the actual ambient pressure in the drying container is kept at atmospheric pressure, i.e., in particular, at about 1000 mbar, preferably under inert gas atmosphere. This is based on the notion that energy or, respectively, heat transfer to the comminuted material becomes the slower the fewer gas or, respectively, air molecules are present in the drying container. Now, if the actual ambient pressure is reduced or, respectively, the gas and air molecules are discharged from the drying container only when the comminuted material has been heated already, the heating of the comminuted material can happen more quickly, making the thermal treatment process in the drying container more efficient overall.

In an alternative, it may also be provided that the actual ambient pressure in the drying container is reduces in accordance with a pre-determined or, respectively, pre-determinable pressure gradient already while the actual ambient temperature in the drying container is brough to the pre-determined final ambient temperature in accordance with a temperature pressure gradient, where the pressure gradient in relation to the temperature gradient is preferably smaller. Thus, the actual ambient pressure will only be slowly reduced (compared to the rise in actual ambient temperature) during the increasing of the actual ambient temperature so that in the beginning there will still be sufficient gas or, respectively, air molecules available in the drying container to heat the comminuted material.

Preferably, it is further provided that the thermal treatment of the comminuted material in the drying container happens discontinuously, where, to that end, the comminuted material to be thermally treated is transferred into the drying container and the drying container is subsequently sealed vacuum-tightly, until the thermally treated comminuted material is transferred to mechanical processing.

Preferably, it is further provided that the comminuted material transferred into the drying container is intermixed and/or loosened before and/or during and/or after the thermal treatment, preferably using a mixing device. This provides the advantage that during the thermal treatment np agglomerates are created and the actual ambient temperature can have an even effect on the entire comminuted material. Furthermore, the free evaporated solvent components can pass into the process gas in an optimum manner and will not remain enclosed inside the material, thereby facilitating the joint or fractional discharging of the solvent components. Hereby, preferably, it is further provided that the mixing device is heated so as to avoid thermal bridges in the drying container during the thermal treatment process.

Preferably, it is further provided that prior to and/or during the thermal treatment of the comminuted material an inert gas is introduced into the drying container. This allows the thermal treatment process to be carried out in a more precisely controlled manner and to minimise further hazards during the thermal treatment in the drying container.

The invention further provides for a processing plant, in particular, for carrying out the method according to the invention, the processing plant comprising at least:
a comminution area including a comminuting chamber for processing provided, possibly prepared, batteries to be recycled to comminuted material and also for thermal pre-treatment;
a drying area for thermal (main) treatment of the comminuted material, including
   a drying container for receiving the comminuted material,
   at least one heater located at least in part in or on the drying container for raising the actual ambient temperature in the drying container, and
   a vacuum pump flow-connected to the drying container via corresponding pressure ducts, for lowering an actual ambient pressure in the drying container;
a mechanical treatment area for subsequent mechanical processing of the thermally treated comminuted material; and
a controller device designed to control at least one heater and the vacuum pump in the drying area such that comminuted material present in the drying container is heated and solvents contained in the comminuted material can evaporate,
where, according to the invention, the controller device is further designed,
to set the actual ambient temperature in the drying container such that the comminuted material present therein is heated to not more than 200° C., and
to set the actual ambient pressure in the drying container such that at the set actual ambient temperature both low-boiling solvents as well as high-boiling solvents can be separated from the comminuted material by evaporation so that the low-boiling solvents and the high-boiling solvents can be discharged from the drying container during the thermal treatment of the comminuted material, at least temporarily together and/or at least temporarily fractionally or, respectively one after another but from the same drying container.

Preferably, it is further provided that the drying container includes an inlet port for feeding-in the comminuted material and an discharge port for discharging the thermally treated comminuted material, the discharge port being arranged on the underside or, respectively, an underside of the drying containers so the thermally treated comminuted material can be discharged from the drying container in the vertical direction. This simplifies complete draining of the drying containers because the comminuted material is moved towards the underside in the direction of the discharge port by gravitation and/or additional overpressure in the drying container.

Preferably, it is further provided that a mixing device is arranged in the drying container for mixing and/or loosening of the comminuted material during thermal treatment. This bears the advantage that during the thermal treatment in the drying container no agglomerates are created and the actual ambient temperature can evenly affect the entire comminuted material. Furthermore, the free evaporated solvent components can pass into the process gas in an optimum manner and will not remain enclosed inside the material, thereby facilitating the joint or fractional discharging of the solvent components. Hereby, preferably, it is further provided that the mixing device is heated so as to avoid thermal bridges in the drying container during the thermal treatment process.

Preferably, it is further provided that the drying container is flow-connected to an exhaust processing device in such a way that the low-boiling solvents and high-boiling solvents separated under thermal treatment of the comminuted material can be discharged to the exhaust processing device during the thermal treatment of the comminuted material together, at least temporarily, and/or separately from one another, at least temporarily, from the same drying container. Thus, the solvents temporarily jointly or temporarily separately evaporating in the same drying container are discharged via the same flow connection without undergoing a prior process separation.

Preferably, it is further provided that an actuator valve is arranged between the drying container and the vacuum pump flow-connected thereto, where the actuator valve can be controlled by the controller device such that the actual ambient pressure in the drying container approaches a pre-determined target ambient pressure. This way a well-controlled pressure adjustment can be carried out, for example, also as part of a regulating process.

The invention is further illustrated below by means of an embodiment example. It is shown in:

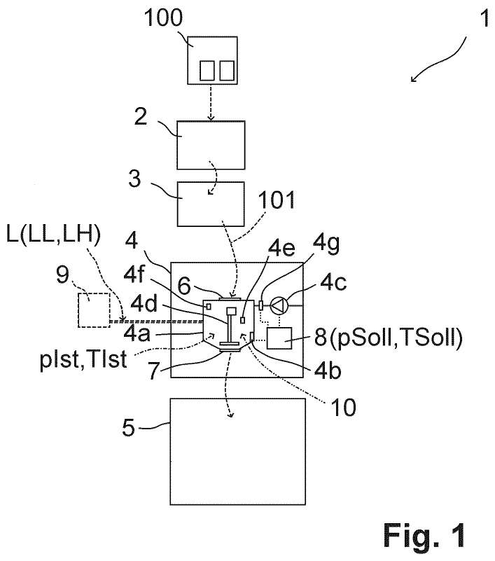

FIG. 1 a schematic view of a processing plant according to the invention; and

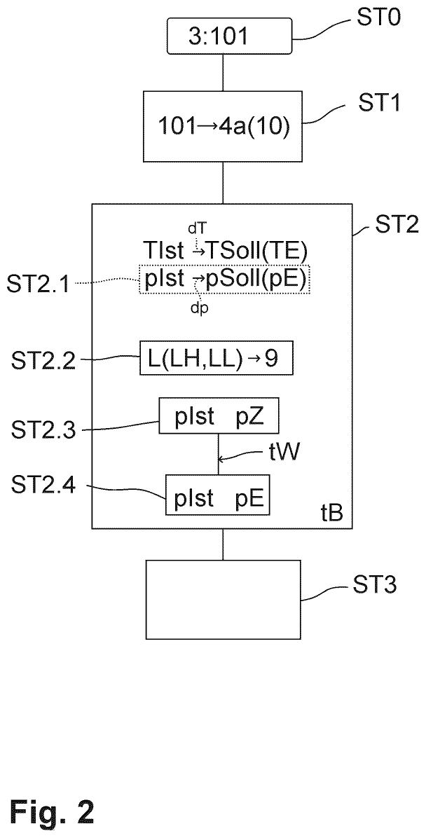

FIG. 2 a flow chart of a method for processing batteries to be recycled.

FIG. 1 shows a simplified scheme of a processing plant 1 for processing batteries 100 to be recycled, in particular, Li-ion batteries. The processing plant 1 is divided into a preparation area 2, a comminution area 3, a drying area 4 and a mechanical processing area 5, where the batteries 100 to be recycled run through the processing arrangement 1 in the afore-mentioned or, respectively, shown sequence.

In the preparation area 2 the batteries 100 to be recycled are prepared for comminution and mechanical treatment, i.e., for example, discharged and/or disassembled and/or further preparatory steps are carried out. In particular. the batteries 100 to be recycled, when supplied or provided, for example, in the form pf battery modules or battery stacks, are broken down to a cell level in the preparation area 2.

In the next following comminution area 3 the prepared batteries 100 are mechanically comminuted in a comminuting chamber 3a, in particular, in an inert atmosphere and under slight negative pressure, so that subsequently a comminuted material 101 is created. This happens, for example, by means of shearing or slicing in a shredder or by smashing or crushing or by cutting shearing or tearing force in combination with bending and torsion e.g., in a granulator. Hereby, the comminuting chamber 3a is heated up to a comminution temperature TZ of, for example, <100° C., to evaporate, at least partially, predominantly water and possibly also low-boiling solvents LS in the ensuing comminuted material 101 and/or the prepared batteries 100 in a thermal pre-treatment, increasing the effectiveness of the subsequent drying process.

In the next following drying area 4 there is a drying container 4a, with at least one heater 4b being arranged (at least in part) in or on the drying container 4a and the drying container 4a being flow-connected to a vacuum pump 4c. The at least one heater 4b can be controlled depending on a pre-determined target ambient temperature TSoll by a controller device 8 such that an actual ambient temperature Tist in the drying container 4a ideally approaches the pre-determined target ambient temperature Tsoll. This can happen, for example, as part of a temperature regulation, where, to that end, a temperature sensor 4e is arranged in the drying container 4a which can detect the current actual ambient temperature Tist in the drying container 4a.

The at least one vacuum pump 4c can be controlled depending on a target ambient pressure pSoll also pre-determined by the controller device 8 such that an actual ambient pressure plst in the drying container 4a approaches the pre-determined target ambient pressure pSoll. This can happen, for example, as part of a pressure regulation, where, to that end, a pressure sensor 4f is arranged in the drying container 4a which can detect the current actual ambient pressure plst in the drying container 4a. Other methods of adjusting the pre-determined target ambient pressure pSoll are conceivable also.

Furthermore, in one embodiment, a actuator valve 4g controllable by the controller device 8 may be provided between the drying container 4a and the vacuum pump 4c, via which the flow connection formed between the vacuum pump 4c and the drying container 4a can be situationally influenced.

The comminuted material 101 discharged from the comminution area 3, which has been thermally pre-treated, can be fed to the drying container 4a via an inlet port 6 and can be discharged again via a discharge port 7 after a drying process (thermal main treatment), in which the comminuted material 101 is thermally treated. Hereby, the discharge port 7 is arranged on the underside of the drying container 4a so that the thermally treated comminuted material 101 can be drained nearly completely from the drying container 4a because this falls vertically down owing to the weight forces and/or an additional overpressure in the drying container 4a. The drying process or, respectively, thermal (main) treatment procedure as such happens by virtue an appropriately selected adjustment of the actual ambient temperature Tist or, respectively, the actual ambient pressure plst in the drying container 4a, so that, as will be further illustrated below, a thermal treatment of the comminuted material 101 happens under separation of various solvents L in the same drying container 4a.

By means of a mixing device 4d arranged in the drying container 4a having a suitable mixing tool the comminuted material 101 can be additionally mixed in the drying container 4a, where the mixing device 4d is accordingly heated too so that the creation of thermal bridges during thermal treatment in the drying container 4a is avoided. The mixing device 4d makes sure that the comminuted material 101 is constantly loosened and no agglomerates are created. As a result of this, after thermal treatment, what can be discharged via the discharge port 7 is an ideally agglomerate-free, granulated comminuted material 101 with a consistently high degree of drying. Subsequently, this well-dried comminuted material 101 can be introduced into the mechanical processing area 5 to be subjected to mechanical processing.

In order to be able to carry out such a mechanical processing of the comminuted material 101, posing only little (chemical) hazard potential, the drying process of the thermal (main) treatment procedure happens using the described plant components as shown by way of example in FIG. 2.

In an initial step ST0, a comminuted material 101 is provided in that the batteries 100 to be recycled, as described above (prepared or unprepared) are processed in the comminution area 3 to a comminuted material 101 and thermally pre-treated (T<100° C.) thereafter. In a first step ST1, the provided comminuted material 101 is fed via the inlet port 6 into the drying container 4a, and thereafter the drying container 4a sealed vacuum-tight, rinsed with nitrogen or, respectively, inert gas 10 to be able to safely hold the actual ambient pressure plst in the drying container 4a under inert gas atmosphere during the subsequent thermal (main) treatment which happens in a dis-continuous manner.

In a second step ST2 the controller device 8 which controls the drying process or, respectively, the thermal treatment process in the drying container 4a indicates a target ambient temperature Tsoll, and the at least one heater 4b is controlled depending upon this. As target ambient temperature Tsoll, for example, an end temperature TE of between 150° C. and 200° C., preferably 150° C., is indicated. Furthermore, the controller device 8 indicates target ambient pressure pSoll and controls the vacuum pump 4c and/or the actuator valve 4g (if present) depending upon this. As target ambient pressure pSoll, for example, an end pressure pE of between 0.01 mbar and 100 mbar, in particular, between 30 mbar and 100 mbar, preferably 30 mbar, is indicated (depending on the vacuum pump 4c utilised).

Hereby, the manner of controlling the at least one heater 4b, the vacuum pump 4c, and/or the actuator valve 4g (if any) can be carried out in different embodiments, as described below:

According to a first embodiment, the at least one heater 4b and the vacuum pump 4c are triggered simultaneously or shortly one after another, while a flow connection between the vacuum pump 4c and the drying container 4a is formed, so as to approach the pre-determined target values (Tsoll, pSoll). This causes the drying container 4a to heat up at falling actual ambient pressure plst, and there is a certain transfer of energy or heat respectively to the comminuted material 101 so that this also heats up, ideally to the pre-determined target ambient temperature Tsoll.

According to a second embodiment, it is provided that the at least one heater 4b is triggered by the controller device 8 while the vacuum pump 4c still remains switched off and/or the flow connection between the drying container 4a and the vacuum pump 4c via the actuator valve 4g is interrupted and, thus, no negative pressure is generated yet in the drying container 4a. Thus, the actual ambient temperature Tist in the drying container 4a is raised, preferably using a high temperature gradient dT, while actual ambient pressure plst remains constant, in particular, at atmospheric pressure (ca. 1000 mbar) under inert gas atmosphere.

After a certain time and/or after a certain rise in the actual ambient temperature Tist in the drying container 4a was detected via the temperature sensor 4e, in a first intermediate step ST2.1, the controller device 8 causes, by means of a corresponding controlling of the vacuum pump 4c and/or the actuator valve 4g (if any), the actual ambient pressure plst in the drying container 4a to drop down to the target ambient pressure pSoll, thereby creating the desired negative pressure in the drying container 4a.

This procedure allows the transfer of energy or heat respectively to the comminuted material 101 to be optimised in this second embodiment: This is because a reduction of the actual ambient pressure plst causes the transfer of energy or heat respectively to the comminuted material 101 to become ever more sluggish because the number of gas or air molecules in the drying container 4a decreases more and more. However, if the actual ambient pressure plst is reduced only after the comminuted material 101 has been heated up, the comminuted material 101 can be brought to the desired ambient temperature Tsoll within a shorter time period.

As an alternative to leaving the vacuum pump 4c switched off initially and/or to completely interrupt the flow connection between the drying container 4a and the vacuum pump 4c via the actuator valve 4g (if any) which the actual ambient temperature Tist in the drying container 4a is increased using a correspondingly high temperature gradient dT, it may be provided that the actual ambient pressure plst is lowered simultaneously (or with a slight time offset) using a smaller pressure gradient dp (small in relation to the temperature gradient dT) in the direction of the target ambient pressure pSoll. Thus, the first embodiment is combines with the second embodiment in the sense that the actual ambient pressure plst drops only very slowly while the actual ambient temperature Tist rises quickly so that at the start of the thermal treatment process in the drying container 4a, while the actual ambient pressures plst is still high (small negative pressure), a good transfer of energy or heat respectively from the at least one heater 4b to the comminuted material 101 in the drying container 4a can be ascertained. Only when the comminuted material 101 has been sufficiently heated will the pre-determined target ambient pressure pSoll the be reached.

Hereby, a smaller pressure gradient dp can be set, for example, by means of an actuator valve 4g which also allows for intermediate positions, for example, a proportional valve or a throttle valve. However, the vacuum pump 4c may also be operated with a fully opened actuator valve 4g (or without an actuator valve 4g in the flow connection) with correspondingly lower power to create less pumping action at the drying container 4a, thereby attaining a lower pressure gradient dp.

In all afore-mentioned embodiments the transfer of energy or heat respectively to the comminuted material 101 in the drying container 4a can be optimised in that the mixing device 4d is triggered by the controller device 8 during the drying process or, respectively, the thermal treatment process. This causes the comminuted material 101 to be mixed ort loosened respectively while being heated so that a consistent drying or thermal treatment respectively within creation of agglomerates can be guaranteed.

Die controller device 8 indicates both the target ambient pressure pSoll as well as the target ambient temperature Tsoll in a purposeful and co-ordinated manner so that a purposeful separation of certain solvents L from the comminuted material 101 can be carried out in the above-described drying process or, respectively, thermal treatment process in the drying container 4a. This is based on the notion that in an electrolyte as a component of the respective battery to be recycled 100 there will be various types of solvents L present, which will still be present in the comminuted material 101 even after comminution. Hereby, in particular. the electrolyte contains high-boiling solvents LH, for example, ethylene carbonate (EC), propylene carbonate (PC), etc., as well as low-boiling solvents LL, for example, dimethyl carbonate (DMC), ethylene methylene carbonate (EMC), diethyl carbonate (DEC), etc., distinguished respectively by their boiling temperatures. While the afore-mentioned high-boiling solvents LH evaporated under atmospheric pressure at actual ambient temperatures Tist of 240° C. or higher, the afore-mentioned low-boiling solvents LL evaporate under atmospheric pressure at actual ambient temperatures Tist of 130° C. or less.

Both solvent components (LL, LH) would present an increased chemical hazard potential in the subsequent mechanical treatment so that these must be separated prior to this, and this happens in above-described drying process or, respectively, thermal (main) treatment procedure in the drying container 4a. However, since at actual ambient temperatures Tist of more than 240° C., as required for evaporating the high-boiling solvents LH, the plastics components in the comminuted material 101 would be brought up to their yield point causing them to begin to melt under persistent thermal treatment, such high actual ambient temperatures Tist should be avoided in the drying process or thermal treatment process in the drying container 4a. Therefore, as described above, the controller device 8 purposefully indicates target ambient temperatures Tsoll of between 150° C. and 200° C., where the plastics components usually do not reach their yield point.

In order for the high-boiling solvents LH to also be able to evaporated already at these target ambient temperatures Tsoll of between 150° C. and 200° C., the actual ambient pressure plst is simultaneously reduced. Hereby, advantage is taken of the fact that the boiling temperatures of the high-boiling solvents LH decrease with a falling actual ambient pressure plst. Hereby, the actual ambient pressure plst can be reduced so substantially, preferably down to less than 100 mbar, in particular, to about 30 mbar, that the high-boiling solvents LH will evaporate already at actual ambient temperatures Tist of under 200° C., for example, at 150° C.

Since the boiling temperatures of the low-boiling solvents LL are lower, even at atmospheric pressure, than these pre-determined 150° C. to 200° C., they will also be evaporating. It follows that upon purposefully selecting the target ambient temperature Tsoll and the target ambient pressure pSoll by the controller device 8 it is mainly the solvent in the electrolyte which is hardest to evaporate that needs to be taken into account, since all earlier evaporating solvents will then automatically also evaporate. Thus, by means of this purposeful and co-ordinated indication of target ambient pressure pSoll and target ambient temperature Tsoll and the subsequent adjustment in the drying container 4a, it can be attained that all (relevant) liquid solvent components (LL, LH) in the comminuted material 101 changed their state from liquid to gaseous without bringing plastics components in the comminuted material 101 to their yield limit at the same time.

In a second intermediate step ST2.2, the low-boiling and high-boiling solvents LL, LH then evaporating at least temporarily together and/or at least temporarily one after another can be discharged temporarily in combination with one another and/or temporarily fractioned from the same drying container 4a via the same flow connection and fed to an exhaust processing means 9 flow-connected to the drying container 4a. Therein, subsequently, an exhaust treatment can be carried out.

To further optimise the entire drying process or thermal treatment process respectively in the drying container 4a, it may be additionally provided that the actual ambient pressure plst in the drying container 4a is intermediately increased again by suitably controlling the vacuum pump 4c and/or the actuator valve 4g (if any) in a third intermediate step ST2.3, where, to that end, for example, the controller device 8 temporarily indicates an intermediate ambient pressure pZ of, for example, 500 mbar or higher as target ambient pressure pSoll, while maintaining the target ambient temperature TSoll of between 150° C. and 200° C., preferably 150° C. Hereby, the pressure increase happens by introducing, for example, nitrogen or another inert gas, so as not to compromise the thermal treatment process in the drying container 4a.

Such in increase in pressure leads to a temporary increase of gas molecules in the drying container 4a so that the transfer of energy or heat respectively from the at least one heater 4b to the comminuted material 101 is improved for a short while and the comminuted material 101 which may have slightly cooled off can re-heat up again. Subsequently in a fourth intermediate step ST2.4, after a holding time tW the final ambient pressure pE of between 0.01 mbar and 100 mbar, in particular, between 30 mbar and 100 mbar, preferably 30 mbar, can be indicated and adjusted again as target ambient pressure pSoll, so as to lower the boiling temperatures of all solvent components (LL, LH) in the re-heated comminuted material 101 to or below the set target ambient temperature TSoll.

The third and fourth intermediate step ST2.3, ST2.4 may be repeated multiple times during the drying process or, respectively, the thermal treatment process in the drying container 4a, where such pulsed modification of the actual ambient pressure plst virtually “triggers” again the evaporation of the respective solvents L, thereby allowing for a reliable separation of all solvent components (LL, LH) in the comminuted material 101.

Hereby, the above-described drying process in the drying container 4a is carried out for a pre-determined treatment time tB which may depend upon which embodiment or, respectively, which intermediate steps ST2.1, ST2.2, ST2.3, ST2.4 are carried out. Hereby, the treatment time tB is determined such that under the prevailing conditions at the respective prevailing actual ambient temperatures Tlst and actual ambient pressures plst it can be assumed that all solvents L (LL, LH) contained in the comminuted material 101 have the opportunity of evaporation as completely as possible. If a thermal pre-treatment in comminuting chamber 3a is provided the treatment time tB may possibly be reduced.

Upon conclusion of the drying process or, respectively, the thermal treatment process in the drying container 4a after the determined treatment time tB, in a third step ST3, the drying container 4a is brought back to atmospheric pressure and the dried or, respectively, thermally treated and solvent free comminuted material 101 discharged from the discharge port 7 and transferred to the mechanical processing area 5 for mechanical processing.

### LIST OF REFERENCE NUMERALS

1 processing plant
2 preparation area
3 comminution area
3a comminuting chamber
4 drying area
4a drying container
4b heater
4c vacuum pump
4d mixing device
4e temperature sensor
4f pressure sensor
4g actuator valve
5 mechanical processing area
6 inlet port
7 discharge port
8 controller device
9 exhaust processing means
10 inert gas
100 batteries to be recycled
101 comminuted material
dp pressure gradient
dT temperature gradient
L solvents
LL low-boiling solvents
LH high-boiling solvents
pE final ambient pressure
plst actual ambient pressure
pSoll target ambient pressure
pZ intermediate ambient pressure
tB processing time
TE final ambient temperature
Tlst actual ambient temperature
TSoll target ambient temperature
TZ comminution temperature
tW holding time
ST1, ST2, ST2.1, ST2.2, ST2.3, ST2.4, ST3 steps of the method

1-20. (canceled)

21. A method for preparing batteries to be recycled, in particular, Li-ion batteries, having at least the following steps:
providing at least one battery to be recycled;
comminuting the provided battery to be recycled in order to obtain comminuted material, the provided battery to be recycled and/or the comminuted material obtained therefrom being thermally pre-treated in a comminuting chamber by being heated up to a comminuting temperature which is lower than 100° C.;
transferring the comminuted material into a drying container and thermally treating the comminuted material by raising an actual ambient temperature and lowering an actual ambient pressure in the drying container in order to heat the comminuted material in the drying container and to vaporise solvents contained in the comminuted material, wherein the actual ambient temperature in the drying container is set such that the comminuted material is heated to no higher than 200° C., and the actual ambient pressure in the drying container is set such that both the low-boiling solvents as well as the high-boiling solvents are separated by being evaporated out of the comminuted material at the set actual ambient temperature, where the low-boiling solvents and the high-boiling solvents are discharged out of the same drying container during the thermal treatment of the comminuted material; and
mechanically processing the thermally treated comminuted material.

22. The method of claim 21, wherein the comminuted material is thermally pre-treated prior to the mechanical processing in the comminuting chamber and is thermally treated in the drying container.

23. The method of claim 21, wherein during the thermal treatment of the comminuted material in the drying container the low-boiling solvents and the high-boiling solvents are discharged together, at least temporarily, and/or separately from one another, at least temporarily, from the same drying container.

24. The method of claim 21, wherein the comminuted material contained in the drying container is not removed from the drying container between the separating of the low-boiling solvents and the separating of the high-boiling solvents, so as to allow for the low-boiling solvents and the high-boiling solvents to be discharged from the same drying container.

25. The method of claim 21, wherein the actual ambient pressure in the drying container is reduced during the thermal treatment of the comminuted material to a final ambient pressure of between 0.01 mbar and 100 mbar, in particular, between 30 mbar and 100 mbar, preferably 30 mbar.

26. The method of claim 25, wherein the actual ambient pressure in the drying container is temporarily increased during the thermal treatment of the comminuted material to a pre-determined intermediate ambient pressure, preferably starting from the previously set final ambient pressure, and after a holding period the actual ambient pressure is reduced again starting from the intermediate ambient pressure, preferably down to the final ambient pressure.

27. The method of claim 26, wherein the intermediate ambient pressure lies, for example, between 500 mbar and 1000 mbar, preferably at 1000 mbar.

28. The method of claim 26, wherein the temporary increasing of the actual ambient pressure in the drying container to the intermediate ambient pressure and the subsequent reducing of the actual ambient pressure after the holding time is carried out multiple times during the thermal treatment of the comminuted material in the drying container.

29. The method of claim 21, wherein the actual ambient temperature in the drying container is brought to a pre-determined final ambient temperature of between 150° C. and 200° C., preferably to 150° C., during the thermal treatment of the comminuted material.

30. The method of claim 29, wherein during the increasing of the actual ambient temperature in the drying container the actual ambient pressure in the drying container is reduced only when the actual ambient temperature in the drying container has reached the pre-determined final ambient temperature, where up to that point the actual ambient pressure in the drying container is maintained at an atmospheric pressure.

31. The method of claim 29, wherein the actual ambient pressure in the drying container is reduced using a pressure gradient while the actual ambient temperature in the drying container is brought to the pre-determined final ambient temperature using a temperature gradient, where the pressure gradient is preferably smaller in relation to the temperature gradient.

32. The method of claim 21, wherein the thermal treatment of the comminuted material in the drying container happens discontinuously, where, to that end, the comminuted material to be thermally treated is transferred into the drying container, and the drying container is subsequently sealed vacuum-tightly, until the thermally treated comminuted material is transferred to mechanical processing.

33. The method of claim 21, wherein the comminuted material transferred into the drying container is intermixed and/or loosened before and/or during and/or after the thermal treatment, preferably using a mixing device.

34. The method of claim 33, wherein the mixing device is heated, at least during the thermal treatment in the drying container.

35. The method of claim 21, wherein prior to and/or during the thermal treatment of the comminuted material, an inert gas is introduced into the drying container.

36. A processing plant for carrying out the method according to claim 21, the processing plant comprising at least:
a comminution area having a comminuting chamber for processing provided batteries to be recycled to comminuted material and for thermal pre-treatment of the provided batteries to be recycled and/or for thermal pre-treatment of the resulting comminuted material by heating up to a comminuting temperature (TZ) which is lower than 100° C.;
a drying area for thermal treatment of the comminuted material, including
a drying container for receiving the comminuted material,
at least one heater located in the drying container for raising the actual ambient temperature in the drying container, and
a vacuum pump flow-connected to the drying container for lowering an actual ambient pressure in the drying container;
a mechanical treatment area for mechanical processing of the thermally treated comminuted material; and
a controller device configured to control at least one heater and the vacuum pump in the drying area such that comminuted material present in the drying container is heated and solvents contained in the comminuted material can evaporate,
wherein the controller device is further configured,
to set the actual ambient temperature in the drying container such that the comminuted material present therein is heated to not more than 200° C., and
to set the actual ambient pressure in the drying container such that at the set actual ambient temperature both low-boiling solvents as well as high-boiling solvents can be separated from the comminuted material by evaporation so that the low-boiling solvents and the high-boiling solvents can be discharged from the drying container during the thermal treatment of the comminuted material from the same drying container.

37. The processing plant of claim 36, wherein the drying container includes an inlet port for feeding-in the comminuted material and an discharge port for discharging the thermally treated comminuted material, the discharge port being arranged on the underside of the drying container so the thermally treated comminuted material can be discharged from the drying container in the vertical direction.

38. The processing plant of claim 36, wherein a mixing device is arranged in the drying container for mixing and/or loosening of the comminuted material during thermal treatment.

39. The processing plant of claim 36, wherein the drying container is flow-connected to an exhaust processing device in such a way that the low-boiling solvents and high-boiling solvents separated under thermal treatment of the comminuted material can be discharged to the exhaust processing device during the thermal treatment of the comminuted material together from the same drying container.

40. The processing plant of claim 36, wherein an actuator valve is arranged between the drying container and the vacuum pump flow-connected thereto, where the actuator valve can be controlled by the controller device such that the actual ambient pressure in the drying container approaches a pre-determined target ambient pressure.
